(19) United States
(12) Patent Application Publication
(10) Pub. No.: US 2026/0129733 A1
(43) Pub. Date: May 7, 2026

(54) WORK LIGHT CONTROL BASED ON CONTEXT DETECTION

(71) Applicant: MILWAUKEE ELECTRIC TOOL CORPORATION, Brookfield, WI (US)

(72) Inventors: Seamus J.D. Herson, Wauwatosa, WI (US); Alexander Yu, Alpharetta, GA (US); Dapeng Zhao, Franksville, WI (US)

(21) Appl. No.: 19/378,560

(22) Filed: Nov. 4, 2025

Related U.S. Application Data
(60) Provisional application No. 63/717,360, filed on Nov. 7, 2024.

(51) Int. Cl. H05B 47/125; F21V 21/22; F21W 131/10; H05B 45/10

(52) U.S. Cl. CPC H05B 47/125; F21V 21/22; H05B 45/10; F21W 2131/1005

(57) ABSTRACT

One example provides a portable lighting device with at least two subsets of light-emitting diodes (LEDs) that are separately controllable to be illuminated at different brightness levels. The lighting device includes an electronic processor coupled to a thermal camera configured to capture a background image and capture current images of an area of operation of the lighting device. The electronic processor is configured to compare the current image to the background image to determine whether and where one or more people is present in the area of operation. The electronic processor is configured to determine a first section in which the one or more people is located, and control the lighting device to more brightly illuminate the first section in which the one or more people is located than a second section of in which people are not located.

### RELATED APPLICATIONS

This application claims priority to U.S. Provisional Patent Application No. 63/717,360, filed on Nov. 7, 2024, the entire contents of which are hereby incorporated by reference.

### FIELD

The present disclosure relates to control of a work light based on context detection performed by the work light. For example, a work light may control one or more light sources in response to detecting one or more users within an area of operation of the work light (e.g., to direct the light toward the one or more users while dimming light output in other directions). As another example, the work light may additionally or alternatively control one or more light sources to reduce or prevent light from being emitted at one or more light-sensitive objects detected by the work light.

### SUMMARY

Work lights, such as free-standing work lights, may be used to illuminate work areas such as construction sites within a building, on a roadway, and/or like. Such work lights may be powered by batteries (e.g., one or more power tool battery packs) to allow for ease of transportation and setup of the work lights.

Work lights may be manually turned off by a user when not in use. However, users often forget to turn off work lights or may choose not to turn off a work light if they are temporarily leaving an area but plan to return to the area later. Accordingly, battery power is wasted by continuing to provide light to an area in which work is not being performed and/or in which a user is not present.

Additionally, work lights often illuminate a large (e.g., wide) area even though an area in which work is being performed by the user(s) is smaller than (i.e., a fraction of) a maximum area of operation to which the work light is capable of providing light. Accordingly, battery power is wasted by providing light to a larger area than is necessary to allow the user(s) to perform work.

The disclosed systems, methods, and devices aim to address the above-noted technological problems by controlling a work light to perform context detection and controlling one or more light sources of the work light based on the context detection. For example, the work light is controlled to detect the presence or absence of a user within an area of operation of the work light. In response thereto, the work light may control one or more light-emitting diodes (LEDs) of its light source to turn on, turn off, decrease brightness, increase brightness, etc. as described in greater detail herein. Different light sources of the work light may be controlled in different manners based on the context detection as described herein.

The disclosed systems, methods, and devices extend the battery life of batteries used to power the light source (and generally reduce energy consumption) without reducing the functionality of the work light with respect to work to be performed by the user(s). Additionally, by the work light (i) providing light to track the user's location within the area of operation of the work light and/or (ii) automatically turning on and/or off depending on whether the user is detected within the area of operation, the work light provides additional automatic functionality that reduces or eliminates user interaction to control the work light. Accordingly, the user is able to more easily perform their work without having to manually adjust the work light as much as may be required with existing work lights or at all. Additionally or alternatively, the work light may automatically control one or more light sources to reduce or prevent light from being emitted at one or more light-sensitive objects detected by the work light, which again provides enhanced functionality without manual user intervention.

One disclosed example provides a lighting device that may include a light source. The light source may include a plurality of light-emitting diodes (LEDs). The lighting device may be a portable lighting device. At least two subsets of LEDs of the plurality of LEDs may be separately controllable to be illuminated at different brightness levels. The lighting device may also include a battery pack configured to provide power to the light source. The lighting device may also include a thermal camera. The lighting device may also include an electronic processor coupled to the thermal camera. The electronic processor may be configured to control the thermal camera to capture a background image of an area of operation of the light source. The electronic processor may also be configured to control the thermal camera to capture a current image of the area of operation of the light source after capturing the background image. The electronic processor may also be configured to compare the current image to the background image to determine whether one or more people is present in the area of operation. The electronic processor may also be configured to determine, in response to determining that the one or more people is present in the area of operation, a first section of the area of operation in which the one or more people is located. The electronic processor may also be configured to control the light source to more brightly illuminate the first section of the area of operation in which the one or more people is located than a second section of the area of operation in which people are not located.

Another disclosed example provides a method of controlling a lighting device. The method may include controlling, with an electronic processor of the lighting device, a thermal camera of the lighting device to capture a background image of an area of operation of a light source of the lighting device. The light source may include a plurality of light-emitting diodes (LEDs). The lighting device may be a portable lighting device. At least two subsets of LEDs of the plurality of LEDs may be separately controllable to be illuminated at different brightness levels. A battery pack coupled to the lighting device may be configured to provide power to the light source. The method may also include controlling, with the electronic processor, the thermal camera to capture a current image of the area of operation of the light source after capturing the background image. The method may also include comparing, with the electronic processor, the current image to the background image to determine whether one or more people is present in the area of operation. The method may also include determining, with the electronic processor and in response to determining that the one or more people is present in the area of operation, a first section of the area of operation in which the one or more people is located. The method may also include controlling, with the electronic processor, the light source to more brightly illuminate the first section of the area of operation in which the one or more people is located than a second section of the area of operation in which people are not located.

Another disclosed example provides a lighting device that may include a light source. The light source may include a plurality of light-emitting diodes (LEDs). The lighting device may be a portable lighting device. At least two subsets of LEDs of the plurality of LEDs may be separately controllable to be illuminated at different brightness levels. The lighting device may also include a battery pack configured to provide power to the light source. The lighting device may also include a camera. The lighting device may also include an electronic processor coupled to the camera. The electronic processor may be configured to detect, using machine vision to analyze data captured by the camera, one or more objects in an area of operation of the light source. The electronic processor may also be configured to identify, using machine vision to analyze the data captured by the camera, an object type of each of the one or more objects. The electronic processor may also be configured to determine, using machine vision to analyze the data captured by the camera, a location and an orientation of each of the one or more objects. The electronic processor may also be configured to determine, at least partially based on the object type, whether the location and the orientation of each of the one or more objects makes a respective object sensitive to light emitted by the light source. The electronic processor may also be configured to in response to determining that the location and the orientation of the respective object makes the respective object sensitive to light emitted by the light source, control the light source to (i) decrease a brightness of LEDs illuminating a first section of the area of operation in which the respective object sensitive to light emitted by the light source is located and (ii) maintain a brightness of LEDs illuminating a second section of the area of operation in which the respective object sensitive to light emitted by the light source is not located.

Before any instances are explained in detail, it is to be understood that the instances are not limited in its application to the details of the configuration and arrangement of components set forth in the following description or illustrated in the accompanying drawings. The instances are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the instances. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some instances, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the instances will become apparent by consideration of the detailed description and accompanying drawings.

### BRIEF DESCRIPTION OF THE DRAWINGS

FIG. 1A illustrates a lighting device, according to some instances described herein.

FIG. 1B illustrates a zoomed-in view of a light source and a thermal camera included on the lighting device of FIG. 1A, according to some instances described herein.

FIG. 2 illustrates a block diagram of a lighting device, such as the lighting device illustrated in FIGS. 1A-1B, according to some instances described herein.

FIG. 3 illustrates a method performed by the lighting device of FIG. 2, according to some instances described herein.

FIG. 4 illustrates an example image comparison that may be performed by the lighting device of FIG. 2 to determine whether a user is present in an area of operation of the lighting device, according to some instances described herein

FIG. 5 illustrates a schematic diagram of select light sources of the lighting device of FIG. 2 being illuminated based on a detected presence of a user in the area of operation of the lighting device, according to some instances described herein.

FIG. 6 illustrates another method performed by the lighting device of FIG. 2, according to some instances described herein.

FIG. 7 illustrates an example of the lighting device of FIG. 2 detecting the presence of users in the area of operation and controlling different light sources (and/or different portions of a light source) of the lighting device in different manners depending on a gaze direction of one or more of the users, according to some instances described herein.

FIG. 8 illustrates an example of a modulated lighting output from the lighting device of FIG. 2 based on detected objects/characteristics in the area of operation of the lighting device, according to some instances described herein.

### DETAILED DESCRIPTION

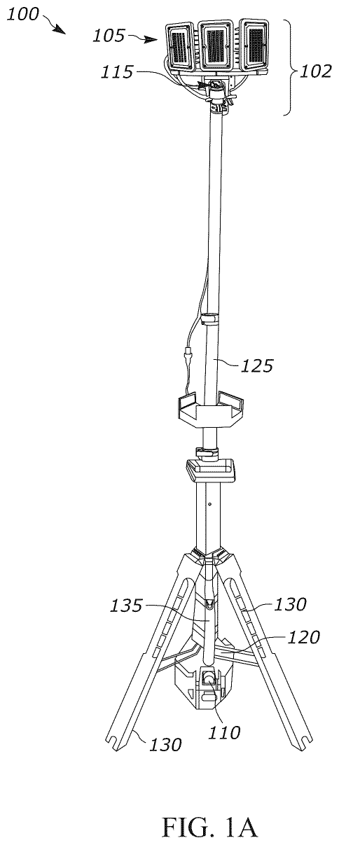

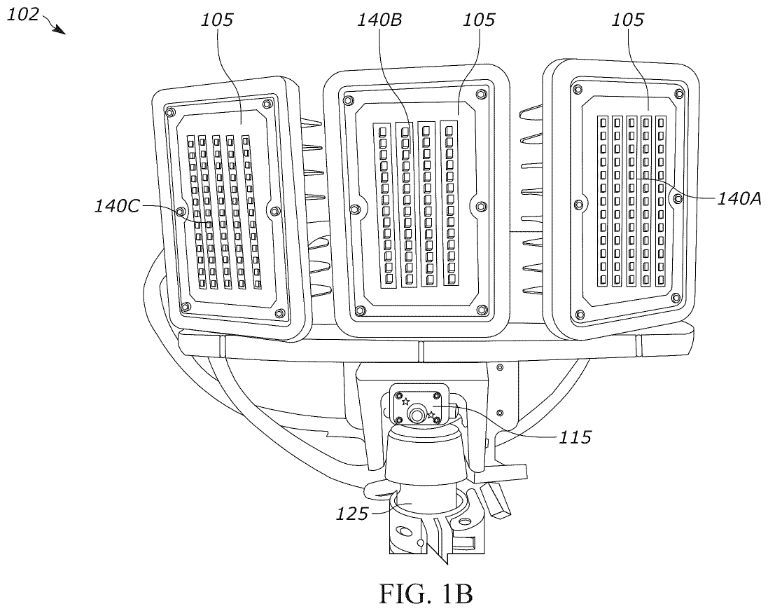

FIG. 1A illustrates a lighting device 100, according to some instances described herein. The lighting device 100 may include a light assembly 102 that includes a light source 105 (e.g., one or more light-emitting diode (LED) arrays) and a vision sensor(s)/system(s) 115 such as a thermal camera 115. The light source 105 and/or the vision system 115 may be powered by a power source 110 (e.g., one or more battery packs such as a power tool battery pack). In some instances, the light source 105 and/or the vision system 115 may be additionally or alternatively powered by power provided from another power source (e.g., via a wall outlet).

In the example shown in FIG. 1A, the lighting device 100 is a portable lighting device embodied as a site light (e.g., a work light) for illuminating a jobsite, such as a construction site, or other large area. As shown in FIG. 1A, the lighting device 100 is a free-standing lighting device 100 configured to stand on the ground and/or a floor without otherwise being supported by another object such as a wall, ceiling, etc. However, in other instances, the lighting device 100 may include a lighting device 100 that is mountable to other objects (e.g., magnetically mounted to a structure, hanging from an object, etc.). In such instances, the lighting device 100 may still be portable and battery-powered. The lighting device 100 shown in FIG. 1A includes a body/housing 120, a telescopic arm assembly 125 supported by the body 120, and the light assembly 102 coupled to the telescopic arm assembly 125 and movable relative to the body 120. The body 120 also includes one or more leg assemblies 130 coupled thereto and configured to provide stability and support for the body 120 during use. The leg assemblies 130 may form a tripod when in an expanded configuration as shown in FIG. 1A. The leg assemblies 130 may be configured to contract toward each other for ease of transportation of the lighting device 100 in a retracted configuration. The telescopic arm assembly 125 may also contract toward the body 120 to be in the retracted configuration. The body 120 may include a handle 135 for ease of transportation in the retracted configuration and/or for ease of adjustment/movement in the expanded configuration (shown in FIG. 1A). The power source 110 is embodied as a power tool battery pack in FIG. 1A and is located at an opposite end (i.e., a bottom end) of the body with respect to the light assembly 102.

An arm of the telescopic arm assembly 125 may include a plurality of concentric tubes nested in order of decreasing width with sufficient clearance therebetween to allow each tube to move axially with respect to one another. Once assembled, the outermost tube (e.g., the tube with largest cross-sectional width) is fixedly mounted to a base of the body 120 concentric with a vertical axis through a center of the base. Furthermore, the innermost tube (e.g. the tube with the smallest cross-sectional width) is coupled to the light assembly 102 for axial movement together therewith. During use, the arm assembly 125 is continuously adjustable between a retracted position, where the arm produces a first arm length (e.g., when the ends of each tube are positioned adjacent one another), and an extended/expanded position, where the arm produces a second arm length that is greater than the first arm length.

FIG. 1B illustrates a zoomed-in view of the light assembly 102 of the lighting device 100 of FIG. 1A, according to some instances described herein. The combination of the light source 105 and the thermal camera 115 may be referred to as the light assembly 102. The light assembly 102 may also include a housing/base to support the light source 105 and the thermal camera 115. The light assembly 102 is coupled to a top portion of the telescopic arm 125. The light source 105 may include a single light source or multiple light sources (e.g., multiple LEDs and/or arrays of LEDs). In some instances, at least two subsets of LEDs of the plurality of LEDs of the light source 105 are separately controllable to be illuminated at different brightness levels as explained herein. In the example shown in FIG. 1B, the light source 105 includes three LED arrays 140: a left LED array 140A, a center/middle LED array 140B, and a right LED array 140C. Each LED array 140 may be separately controllable to be turned on/off and/or illuminated at different brightness levels. In some instances, one or more LEDs within each LED array 140 also may be separately controllable to be turned on/off and/or illuminated at different brightness levels. For example, to support the modulation of individual areas of light output, electrically actuated switches (e.g., in the form of mechanical relays, solid state switches like MOSFETs or IGBTs, etc.) are included in series to control individual LEDs or groups/subsets of LEDs that are meant to be modulated together. These switches can be controlled to be in the OFF or ON state, and/or can be driven with a pulse width modulated signal to synthesize a brightness in between the ON or OFF state.

The LED arrays 140 are shown in FIG. 1B as being separately mounted to a portion of the light assembly 102 and a direction of their light output may be independently adjustable with respect to each other. For example, a housing of each LED array 140 may be configured to independently swivel, pan, tilt, etc. with respect to other LED arrays 140. Such adjustment may be manual or automatic/automated (e.g., using one or more motors such as servo motors). In other instances, multiple LED arrays 140 whose brightness is independently/separately controllable may all be included within a single housing that is configured to swivel, pan, tilt, etc. with respect to the light assembly 102 and/or the body/housing 120 of the lighting device 100 (e.g., manually or automatically).

As shown in the example of FIG. 1B, the thermal camera 115 (or other vision sensor/system 115) is located adjacent the light source 105 (e.g., underneath and proximal to the light source 105) to monitor an area of operation of the light source 105. The area of operation of the light source 105 may include area in which light emitted from the light source 105 is capable of illuminating (e.g., a conically shaped area, a rectangular shaped area, or the like). For example the area of operation of the light source 105 may be a maximum area of illumination of the light source 105 that receives a certain amount of luminance from the light source 105 when all LEDs are illuminated. In some instances, the thermal camera 115 is mounted adjacent to the light source 105 and is configured such that a field of view of the thermal camera 115 corresponds approximately to the area of operation (i.e., a maximum area of illumination) of the light source 105. In some instances, a characteristic of the thermal camera 115 may be set to correspond to the area of operation of the light source 105. For example, a lens of the thermal camera 115 may be adjusted such that a field of view of the thermal camera 115 corresponds approximately to the area of operation (i.e., a maximum area of illumination) of the light source 105. While the thermal camera 115 is mounted below the light source 105 in the example shown in FIG. 1B, the thermal camera 115 may be mounted in additional and/or alternative locations. For example, the thermal camera 115 may be mounted above the light source 105, and/or a thermal camera 115 may be mounted between each LED array 140. In some instances, more than one thermal cameras 115 and/or other types of cameras (e.g., RGB camera(s)) may make up the vision system 115.

The lighting device 100 shown in FIGS. 1A and 1B is merely one example lighting device that may include the features and functionality described herein. In some instances, the lighting device 100 may alternatively be a different portable lighting device (e.g., a compact site light, a lantern-type light, or the like). In some instances, the lighting device 100 may include additional features or may include less features than those shown in FIGS. 1A and 1B. For example, the lighting device 100 may not include the telescopic arm assembly 125. As another example, the lighting device 100 may include more or fewer leg assemblies 130. As another example, the housing 120 of the lighting device 100 may include two or more wheels to allow for ease of transportation of the lighting device 100. As yet another example, the housing 120 may include additional battery receptacles (e.g., two or more battery receptacles) such that the lighting device 100 is configured to simultaneously receive multiple battery packs. In some instances, the lighting device 100 may be a stationary/permanently mounted lighting device that may not be portable. In some instances, the area of operation (i.e., a maximum area of illumination) of the light source 105 may be different (e.g., approximately 90 degrees of width coverage, approximately 180 degrees of width coverage, 360 degree width coverage, values in between these coverage widths, or the like).

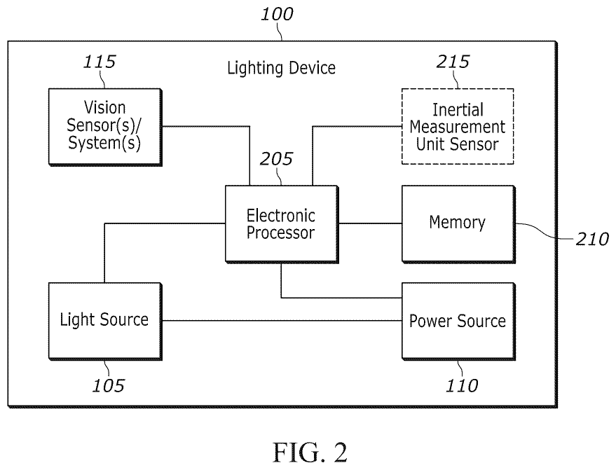

FIG. 2 illustrates a block diagram of the lighting device 100, according to some instances described herein. As shown in the example of FIG. 2, the lighting device 100 includes an electronic processor 205, a memory 210, the power source 110, the light source 105, and the vision sensor(s)/system(s) 115. The electronic processor 205 is electrically coupled to a variety of components of the lighting device 100 and includes electrical and electronic components that provide power, operational control, and protection to the components of the lighting device 100. In some instances, the electronic processor 205 includes, among other things, a processing unit (e.g., a microprocessor, a microcontroller, or another suitable programmable device), a memory, input units, and output units. The processing unit of the electronic processor 205 may include, among other things, a control unit, an arithmetic logic unit (“ALU”), and a plurality of registers. In some instances, the electronic processor 205 is implemented partially or entirely on a semiconductor (e.g., a field-programmable gate array [“FPGA”] semiconductor) chip, such as a chip developed through a register transfer level (“RTL”) design process.

In some instances, the electronic processor 205 is implemented within a distributed system including one or more components of the lighting device 100 and/or components located remotely from the lighting device 100. For example, in some instances, the electronic processor 205 includes local hardware components and one or more remote hardware components (e.g., cloud-based components, hosted on public and/or private cloud infrastructure, Software as a Service (SaaS), Platform as a Service (PaaS), etc.). In other words, the electronic processor 205 may include any one or a combination of electronic processors located within a single device (e.g., the lighting device 100 and/or its components such as thermal camera 115) or distributed among various devices and/or systems (e.g., the lighting device 100, a cloud-based device, etc.). For example, the electronic processor 205 may include a first electronic processor of the lighting device 100, a second electronic processor of the thermal camera 115, a remote electronic processor configured to communicate with the lighting device 100, or any combination thereof. Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed within a single device (such as within the housing 120 and/or the light assembly 102 of the lighting device 100) or across multiple devices.

In some instances, the memory 210 includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The electronic processor 205 is electrically coupled to the memory 210 and executes instructions that are capable of being stored in a RAM of the memory 210 (e.g., during execution), a ROM of the memory 210 (e.g., on a generally permanent basis), or another non-transitory computer readable medium such as another memory or a disc. The electronic processor 205 is configured to retrieve from memory and execute, among other things, instructions related to the control processes, algorithms, and methods described herein. The electronic processor 205 is also configured to store information on the memory 210.

In some instances, the power source 110 is coupled to and transmits power to the electronic processor 205 and to the light source 105. In some instances, an interface (e.g., a battery receptacle and associated circuitry) of the lighting device 100 that is configured to couple to the power source 110 includes combinations of active and passive components (e.g., voltage step-down controllers, voltage converters, rectifiers, filters, etc.) to regulate or control the power provided to the electronic processor 205 and/or the light source 105. In some instances, the power source 110 is configured to provide a drive current to the light source 105 based on control signals received from the electronic processor 205 to control an intensity of the light source 105. In some instances, the electronic processor 205 is configured to control the drive current provided by the power source 110 to the light source 105 by controlling a pulse width modulation (PWM) duty cycle that controls when the power source 110 provides the drive current to the light source 105. In some instances, the electronic processor 205 controls the drive current provided to different LEDs of the light source 105 in different manners (i.e., independent control of LEDs, LED arrays, etc.) as explained herein. In other words, at least two subsets of LEDs of the plurality of LEDs of the light source 105 are separately/independently controllable by the electronic processor 205 to be illuminated at different brightness levels.

The vision sensor(s)/system(s) 115 may include one or more thermal cameras 115. In some instances, the vision sensor(s)/system(s) 115 additionally or alternatively includes one or more other cameras (e.g., an RGB camera, an RGBD camera, etc.). In some instances, the vision sensor(s)/system(s) 115 additionally or alternatively include one or more visible light cameras and/or sensors (e.g., an ambient light sensor). The vision system 115 may allow the electronic processor 205 to perform computer/machine vision presence detection, for example, to detect one or more users and/or other objects based on analysis of data captured by the camera(s) (e.g., analysis of images and/or videos captured by the camera(s)). Other vision sensors/systems may additionally or alternatively be used.

In some instances, the lighting device 100 includes additional, fewer, or different components than the components shown in FIG. 2 and/or the components of the lighting device 100 may be in configurations different from that illustrated in FIG. 2. For example, the lighting device 100 may additionally include one or more inertial measurement unit (IMU) sensors 215 (e.g., one or more accelerometers) to determine when the lighting device 100 is bumped and/or is moved and/or adjusted (e.g., to illuminate a different area). As another example, the lighting device 100 may include a user interface (e.g., a touchscreen and/or a push button that act as one or more user input buttons to provide commands to the lighting device 100 as described herein). As another example, the lighting device 100 may include additional sensors such as current and/or voltage sensors that measure the current being drawn by the light source 105 (i.e., drive current) and/or the voltage of the power source 110. As another example, the lighting device 100 may include a network interface that includes a transceiver and an antenna to allow the electronic processor 205 to bidirectionally communicate with other devices (e.g., other lighting devices, communication devices such as smart phones, tablets, etc., and/or the like). As another example, not all communicative connections between components of the lighting device 100 may be shown in FIG. 2. For example, components that are not shown as being directly connected to each other (e.g., the power source 110 and the memory 210, the power source 110 and the vision sensor(s)/system(s) 115, etc.) may be directly connected to each other. In some instances, the lighting device 100 performs at least one additional functionality than the functionality described herein.

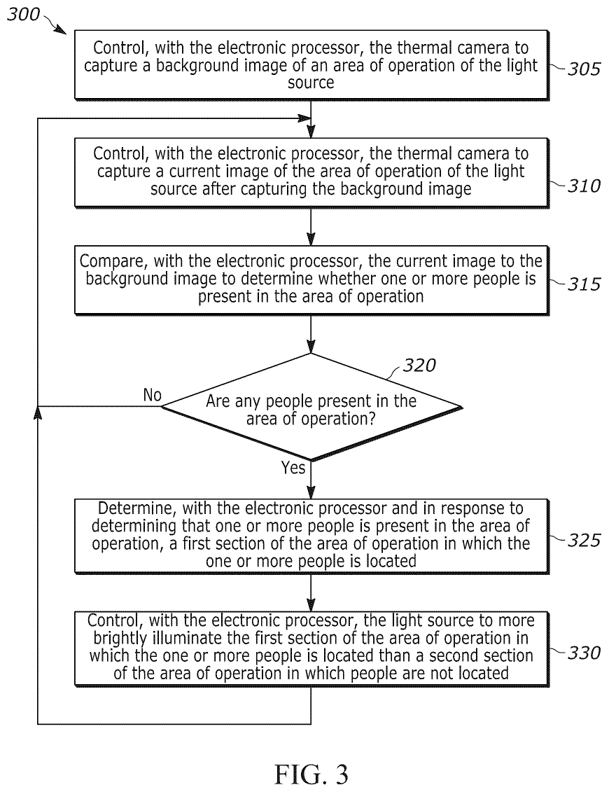

FIG. 3 illustrates a method 300 of controlling the lighting device 100 according to some instances described herein. While a particular order of processing steps, message receptions, and/or message transmissions is indicated in FIG. 3 as an example, timing and ordering of such steps, receptions, and transmissions may vary where appropriate without negating the purpose and advantages of the examples set forth in detail throughout the remainder of this disclosure.

In some instances, the method 300 is performed by the electronic processor 205 of the lighting device 100. As explained previously herein, the electronic processor 205 performing the method 300 may include any one or a combination of electronic processors within the lighting device 100 and/or distributed across one or more other devices that are in communication with the lighting device 100. In other words, regardless of which specific electronic processors perform all or portions of the method 300, an entity performing the method 300 may be referred to as the electronic processor 205, which may include one or more electronic processors or other components within the lighting device 100.

Before the method 300 is initiated, a user may set up the lighting device 100 in a location to provide light (e.g., a construction site within a building, on a roadway, and/or like; another work site; a campground; and/or the like). When the lighting device 100 is set up in a location to provide light, at block 305, the electronic processor 205 controls the vision system 115 (e.g., one or more thermal cameras 115) to capture a background image of an area of operation (e.g., a maximum area of illumination) of the light source 105. The electronic processor 205 may be configured to register/save the background image in the memory 210.

In some instances, the background image capture (at block 305) is performed only once at each location in which the lighting device 100 is set up for use or may be performed multiple times at each location due to different triggering events. For example, the lighting device 100 may include a button to be actuated by a user to turn on the lighting device 100 once the user has set up the lighting device 100 in a desired location. In response to actuation of this button, the background image is captured or re-captured (at block 305) and is used as the background image until the button is re-actuated or until the electronic processor 205 detects that the lighting device 100 has been moved (e.g., based on signals received from the IMU sensor 215 as explained herein). In some instances, the lighting device 100 may have a separate on/off button and background capture button. In such instances, actuation of the background capture button causes the electronic processor 205 to re-capture a new background image (i.e., restart the method 300 by returning to block 305). As explained above, in some instances, the electronic processor 205 is configured to control the thermal camera 115 to capture the background image in response to receiving, via a user interface, a user input.

The above-described buttons may be provided on a touchscreen or other user interface of the lighting device 100 (e.g., located on the housing 120 of the lighting device 100 and/or located on an external device (e.g., smart phone, etc.) configured to communicate with the lighting device 100). Additionally or alternatively, the above-described buttons may include physical/mechanical buttons (e.g., push buttons) on the lighting device 100. The user interface of the lighting device 100 and/or the external device may include additional user inputs and/or user outputs (e.g., user inputs to allow the user to set a runtime and/or brightness of the light source 105 or portions thereof; user outputs to provide status information to the user such as battery charge level, brightness level, scheduled runtime, and/or the like; and/or the like).

In some instances, the electronic processor 205 is configured to determine, based on data received from the IMU sensor 215, that the lighting device 100 has been moved after the background image has been captured (i.e., after execution of block 305 and during performance of other blocks of the method 300). For example, in response to determining that an angular rate from the IMU sensor 215 is greater than a predetermined threshold and/or has changed repeatedly for longer than a predetermined time threshold (e.g., which may be indicative of the lighting device 100 being carried or transported from one location to another location), the electronic processor 205 may re-capture a new background image once the data from the IMU sensor 215 indicates that the lighting device 100 has stopped moving and is set up in a standing/expanded position. In response to determining that the lighting device 100 has been moved after the background image has been captured, the electronic processor 205 may cease capturing new/additional current images (and performing other steps of the method 300) and may continue to monitor movement of the lighting device 100 to determine when the lighting device 100 has stopped moving. Based on data from the IMU sensor 215, the electronic processor 205 may determine that the lighting device 100 has stopped moving and is stationary. The electronic processor 205 may also determine that the lighting device 100 has remained on (e.g., in an operational/expanded state) rather than being turned off and/or retracted into a retracted state. For example, movement of the lighting device 100 while the lighting device 100 remains operational may have been caused by a large wind gust or by an accidental bumping by a user, pedestrian, etc. As another example, movement of the lighting device 100 while the lighting device 100 remains operational may have been caused by a user adjusting a position/orientation and/or location of the lighting device 100 to illuminate a different area (e.g., a construction worker adjusting the direction of light emission at a construction site). In some instances, the electronic processor 205 controls the thermal camera 115 to re-capture a second background image in response to determining that the lighting device 100 has stopped moving and is stationary (after detecting that the lighting device 100 was moved after the first/original background image was captured).

At block 310, the electronic processor 205 controls the thermal camera 115 to capture a current image of the area of operation of the light source 105 after capturing the background image. Because the thermal camera 115 and lighting device 100 are in the same position/orientation and location when the current image is captured at block 310 as when the background image was captured at block 305, the images can be compared to identify objects (e.g., one or more people and/or other objects) that have moved into and/or out of the area of operation of the light source 105.

At block 315, the electronic processor 205 compares the current image (e.g., the current thermal image) to the background image (e.g., the saved background thermal image) to determine whether one or more people is present in the area of operation. In some instances, the electronic processor 205 compares a current temperature of each pixel (or group of pixels) of the current image to a background temperature of a corresponding pixel (or corresponding group of pixels) of the background image. While a pixel-by-pixel analysis may be performed, in some instances groups of nearby, contiguous pixels may be analyzed together since detected objects such as people are likely to be included in many pixels due to their size. Accordingly, analyzing groups of nearby, contiguous pixels may save processing time and/or power while providing the same or similar results.

In some instances, the electronic processor 205 determines that the background temperature of a first pixel (or group of pixels) in the background image is greater than the current temperature of the first pixel (or group of pixels) in the current image. In some instances, in response to determining that the background temperature of the first pixel (or group of pixels) in the background image is greater than the current temperature of the first pixel (or group of pixels) in the current image, the electronic processor 205 flags the first pixel (or group of pixels) as not including people. Additionally, in some instances, in response to determining that the background temperature of the first pixel (or group of pixels) in the background image is greater than the current temperature of the first pixel (or group of pixels) in the current image, the electronic processor 205 may set the background temperature of the first pixel (or group of pixels) in the background image to be a value of the current temperature of the first pixel (or group of pixels) in the current image. For example, temperature values of the background image may be stored in the memory 210 when the background image is captured (at block 305). The electronic processor 205 may update the stored temperature value of the background image based on the current temperature of the first pixel (or group of pixels) being less than initially measured which indicates the absence of people in the first pixel (or group of pixels). Such updating allows the electronic processor 205 to account for other environmental changes in the area of operation and better detect people (and/or other objects) that may move to be located in the area represented by the first pixel (or group of pixels) in the future.

On the other hand, in some instances, the electronic processor 205 determines that the background temperature of a second pixel (or group of pixels) in the background image is less than the current temperature of the second pixel (or group of pixels) in the current image by a predetermined threshold. For example, the current temperature being greater than the background temperature by a predetermined amount may indicate the presence of a person (or a portion of a person) because the person's body temperature is usually higher than the temperature of inanimate objects otherwise captured by in a current image when the person is present. In some instances, the electronic processor 205 may additionally or alternatively determine whether the current temperature of the second pixel (or group of pixels) is within a predetermined range of temperatures corresponding to a human (e.g., 96-99 degrees Fahrenheit, or the like).

In some instances, in response to determining that the background temperature of the second pixel in the background image is less than the current temperature of the second pixel in the current image by the predetermined threshold (i.e., that the current temperature is greater than the background temperature by a predetermined amount), the electronic processor 205 flags the second pixel as including the one or more people. In some instances, in response to determining that the current temperature of the second pixel in the current image is within the predetermined range of temperatures corresponding to a human, the electronic processor 205 flags the second pixel as including the one or more people.

At block 320, the electronic processor 205 determines whether there are any people present in the area of operation of the light source 105. In some instances, the electronic processor 205 determines the presence of a human in response to determining that a size/area of a contiguous pixels (or groups of pixels) flagged as including a person is greater than a predetermined threshold. In some instances, the electronic processor 205 determines the presence of a human in response to determining that a shape of a pixels (or groups of pixels), such as contiguous pixels, flagged as including a person is similar to the shape of a human body (e.g., a head/face and arms and/or legs within a predetermined distance of the head/face). Other manners of detecting people from thermal images may additionally or alternatively be used. In some instances, if a single or a few pixels (or a single or a few groups of pixels) flagged as including a person do not have a size/area greater than the predetermined threshold and/or are not in a recognizable shape/pattern corresponding to a human, the electronic processor 205 may not detect a person despite the flagging of such pixels as including a person.

When the electronic processor 205 determines that there are not any people present in the area of operation (at block 320), the method 300 proceeds back to block 310 to repeat most blocks of the method 300 except block 305. For example, the electronic processor 205 repeatedly (e.g., continuously, periodically, etc.) captures current images of the area of operation as people and objects move into and out of the area of operation, and compares the current images to the background image to detect the presence and/or absence of one or more people. On the other hand, when the electronic processor 205 determines that there is one or more people present in the area of operation (at block 320), the method 300 proceeds to block 325.

At block 325, the electronic processor 205 determines, in response to determining that the one or more people are present in the area of operation, a first section of the area of operation in which the one or more people is located. The first section may include a single first section where one or more people is located or may include multiple first sections (e.g., separate, non-contiguous sections) where each of multiple people are separately located (e.g., one or more people on the left side of the area of operation and one or more people on the right side of the area of operation).

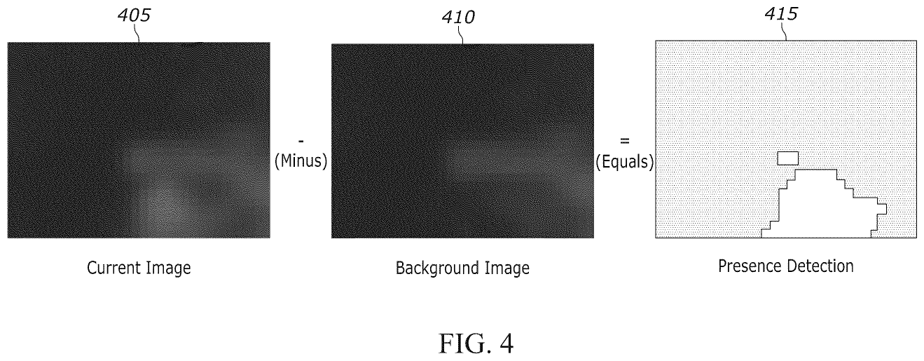

For example, FIG. 4 illustrates an example image comparison of a current thermal image 405 to a stored background thermal image 410 that may be performed by the electronic processor 205 (at blocks 310, 315, 320, and 325) to determine whether one or more people is present in one or more sections of the area of operation of the light source 105 of the lighting device 100. The result of the comparison of the current image 405 to the background image 410 may result in a comparison image 415 that indicates differences between the current image 405 and the background image 410. Such differences may indicate the presence of people as explained previously herein. In the example shown, the electronic processor 205 detects the presence of one or more people in the lower right portion of the area of operation of the light source 105 as shown in the comparison image 415 of FIG. 4.

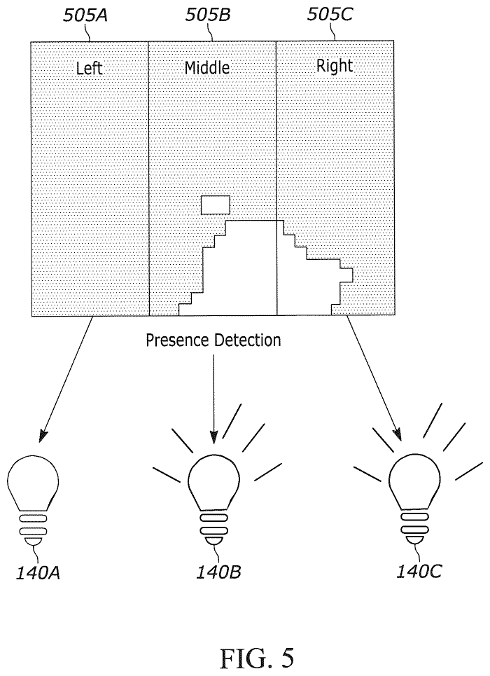

At block 330, the electronic processor 205 controls the light source 105 to more brightly illuminate the first section of the area of operation in which the one or more people is located than a second section of the area of operation in which people are not located. For example, based on the presence detection at block 325, the electronic processor 205 may control the light source 105 to illuminate only the center LED array 140B and the right LED array 140C (as shown in FIG. 5) since the presence of one or more people was detected in only a right section 505C and a middle/center section 505B of the area of operation of the lighting device 100 and not in a left section 505A. Accordingly, the left LED array 140A may be turned off, may remain off, or may be illuminated at a lesser brightness level to save energy since lighting the left section 505A of the area of operation of the lighting device 100 is likely less useful to the user given the detected presence/positioning of one or more people in the right section 505C and the middle section 505B of the area of operation.

While FIG. 5 includes an example with three LED arrays that correspond to three subsets of LEDs of the light source 105, light modulation resolution (i.e., control granularity) may be different in some instances depending on individual control capabilities of the LEDs of the light source 105. For example, the lighting device 100 may also turn off or dim an upper subset of LEDs that illuminate a top section of each section 505 of the area of operation of the lighting device 100 since the user is present in only the lower portion of the area of operation as shown in FIGS. 4-5. In other words, depending on individual control capabilities of the LEDs (e.g., how many LEDs or subsets of LEDs are individually/separately controllable), the sections 505 of the area of operation in which the electronic processor 205 controls LEDs to illuminate may be less than or greater than three sections 505 as shown in FIG. 5. For example, the example above with top sections for each section 505 would include six different individually controllable subsets of LEDs that each illuminate a respective section of the six sections of the area of operation.

As indicated above, in some instances, the electronic processor 205 may determine that multiple people are separately located in separate, non-contiguous sections of the area of operation and control the light output to provide brighter light to those respective sections. For example, one person may be detected in the left section 505A of the area of operation and one person may be detected in the right section 505C of the area of operation. In this example, the electronic processor 205 controls the light source 105 to more brightly illuminate the left section 505A and the right section 505C in which the one or more people is located than the middle section 505B in which people are not located.

In some instances, the electronic processor 205 correlates pixels of captured images from the vision system 115 (e.g., thermal camera 115) with LEDs of the light source 105 (e.g., subsets of LEDs of the light source 105). For example, the number of pixels across a width of a captured image may be four times higher than the amount of the LEDs across a width of the light source 105. Continuing this example, the number of pixels across a height of the captured image may be two times higher than the amount of LEDs across a height of the light source 105. Accordingly, the electronic processor 205 may determine that each four by two subgroup of pixels on the captured image corresponds to a LED of the light source 105 (e.g., if each LED is individually controllable). The electronic processor 205 may use this relationship to determine which LEDs (e.g., subsets of LEDs of the light source 105) correspond to sections of the area of operation where one or more people have been detected based on captured images. The numerical relationship above is merely an example. The actual relationship between pixels in captured images and LEDs of the light source 105 may be different depending on camera resolution and type of light source 105 (e.g., number of LEDs and/or size of a LED matrix).

As indicated in FIG. 3, after execution of block 330, the method 300 proceeds to block 310 to repeat most blocks except block 305, for example, to continue gathering new/additional current thermal images and comparing them to the background thermal image. Accordingly, unlike some motion detection lights that turn off when movement is not detected for a predetermined period of time, the electronic processor 205 is configured to control the light source to illuminate the first section of the area of operation in which the one or more people is located regardless of whether the one or more people has remained stationary for a period of time. In other words, the subset of LEDs of the lighting device 100 that are providing light to an area/section where the user is detected continue to provide light output as long as the user is detected within the area of operation regardless of whether the user has remained stationary for an extended period of time.

Additionally, through repetition of some or all of the blocks of the method 300 of FIG. 3, the electronic processor 205 may be configured to dynamically (and independently/separately) control a brightness of the at least two subsets of LEDs to provide light to different sections of the area of operation as the one or more people move within the area of operation by repeatedly (i) controlling the thermal camera 115 to capture additional current images of the area of operation of the light source 105 (at block 310), (ii) comparing each additional current image to the background image to determine whether one or more people is present in the area of operation (at block 315), (iii) determining, in response to determining that the one or more people are present in the area of operation (at block 320), the first section of the area of operation in which the one or more people is located (at block 325), and (iv) controlling the light source 105 to more brightly illuminate the first section of the area of operation in which the one or more people is located than a second section of the area of operation in which people are not located (at block 330). Accordingly, the light output from the lighting device 100 is configured to dynamically “follow” the user (e.g., with brighter light) while turning off or dimming subsets of LEDs that are less likely to provide useful light output (e.g., subsets of LEDs that would illuminate an area in which the user(s) is not located) based on the current detected position of the user(s) within the area of operation.

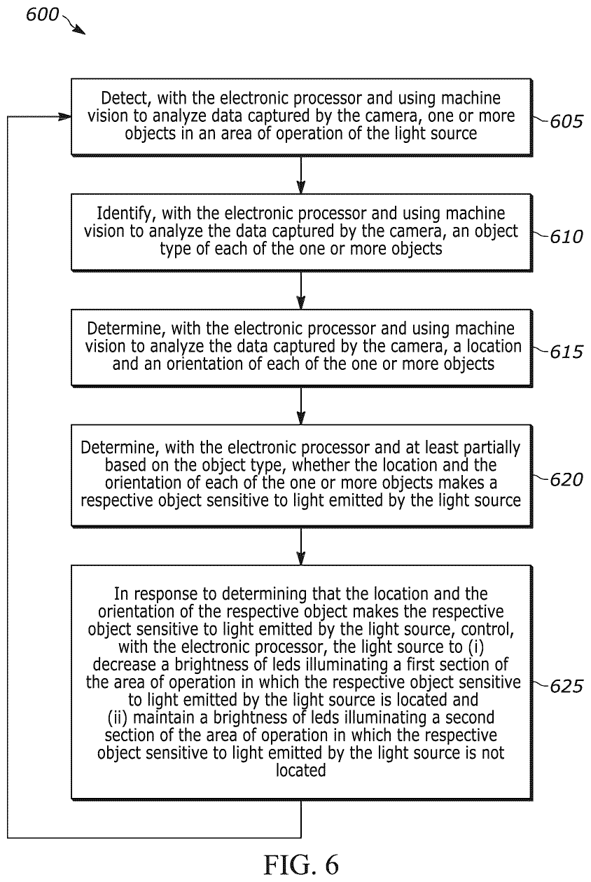

FIG. 6 illustrates another method 600 of controlling the lighting device 100 according to some instances described herein. For example, the method 600 may be executed to detect the presence of objects in the area of operation and control different LEDs (e.g., subsets of LEDs) of the light source 105 of the lighting device 100 in different manners (e.g., at different brightness levels) depending on whether one or more of the objects detected in the area of operation are light-sensitive. While a particular order of processing steps, message receptions, and/or message transmissions is indicated in FIG. 6 as an example, timing and ordering of such steps, receptions, and transmissions may vary where appropriate without negating the purpose and advantages of the examples set forth in detail throughout the remainder of this disclosure. In some instances, the method 600 is performed by the electronic processor 205 of the lighting device 100, which may include any one or a combination of electronic processors within the lighting device 100 and/or distributed across one or more other devices that are in communication with the lighting device 100 as explained previously herein.

At block 605, the electronic processor 205 detects, using machine vision to analyze data captured by the camera 115 (i.e., vision system 115), one or more objects in an area of operation of the light source 105. The camera 115 may include one or more RBG cameras and/or other cameras that capture data such as images and/or video of the area of operation of the light source 105. The camera 115 may function similarly to and be located in a similar position as the thermal camera 115 described previously herein. Accordingly, the camera 115 will not be re-described in detail with respect to the method 600 of FIG. 6.

At block 610, the electronic processor 205 identifies, using machine vision to analyze the data captured by the camera 115, an object type of each of the one or more objects. For example, detectable objects may include people, animals, vehicles, and/or other objects. In some instances, the electronic processor 205 uses pre-trained machine learning models to detect and/or identify objects at blocks 605 and 610.

At block 615, the electronic processor 205 determines, using machine vision to analyze the data captured by the camera 115, a location and an orientation of each of the one or more objects. For example, the electronic processor 205 may determine a gaze direction of one or more people detected in the area of operation and/or a distance between each of the one or more people and the lighting device 100. As another example, the electronic processor 205 may determine whether a vehicle is moving or stationary, a direction that a vehicle is traveling in the area of operation, and/or a distance between the vehicle and the lighting device 100. In some instances, the electronic processor 205 uses pre-trained machine learning models to determine the location and/or orientation of objects at block 615.

At block 620, the electronic processor 205 determines, at least partially based on the object type, whether the location and the orientation of each of the one or more objects makes a respective object sensitive to light emitted by the light source 105. For example, the electronic processor 205 may determine that a first person is sensitive to light emitted by the light source 105 based on determining that the gaze direction of the first person is toward the light source 105 and/or the first person is within a predetermined distance of the light source 105. As another example, the electronic processor 205 may determine that a moving vehicle is sensitive to light emitted by the light source 105 based on determining that a moving vehicle is traveling in a manner where a front or rear of the vehicle is facing the light source 105 and/or the moving vehicle is within a predetermined distance of the light source 105. On the other hand, the electronic processor 205 may determine that a second person is not sensitive to light emitted by the light source 105 based on determining that the gaze direction of the second person is away from the light source 105 and/or the second person is not within a predetermined distance of the light source 105. Similarly, the electronic processor 205 may determine that a vehicle is not sensitive to light emitted by the light source 105 based on determining that the vehicle is not moving, is not within a predetermined distance of the light source 105, and/or is not traveling in a manner where a front or rear of the vehicle is facing the light source 105.

At block 625, in response to determining that the location and the orientation of the respective object makes the respective object sensitive to light emitted by the light source 105, the electronic processor 205 controls the light source 105 to (i) decrease a brightness of LEDs (e.g., subset of LEDs) illuminating a first section of the area of operation in which the respective object sensitive to light emitted by the light source 105 is located and (ii) maintain a brightness of LEDs (e.g., a different subset of LEDs) illuminating a second section of the area of operation in which the respective object sensitive to light emitted by the light source 105 is not located. The sections (i.e., the first section and the second section) may each include a single section where one or more light-sensitive objects is located or may include multiple sections (e.g., separate, non-contiguous sections) where each of multiple light-sensitive objects are separately located (e.g., one light-sensitive object on the left side of the area of operation and one light-sensitive object on the right side of the area of operation).

In some instances, decreasing the brightness of the LEDs illuminating the first section includes dimming or turning off the LEDs illuminating the first section. In some instances, the LED illuminating the first section may be dimmed to a lower brightness level that still illuminates the entire area of operation enough to allow the camera 115 to continue to capture bright enough images that allow the electronic processor 205 to use machine vision to analyze the data from the camera 115 to continue executing the method 600 through repetition. As indicated in FIG. 6, after execution of the block 625, the method 600 repeats to continue monitoring the area of operation of the light source 105 and adjusting light output of one or more subsets of LEDs based on the detected presence and/or absence of light-sensitive objects.

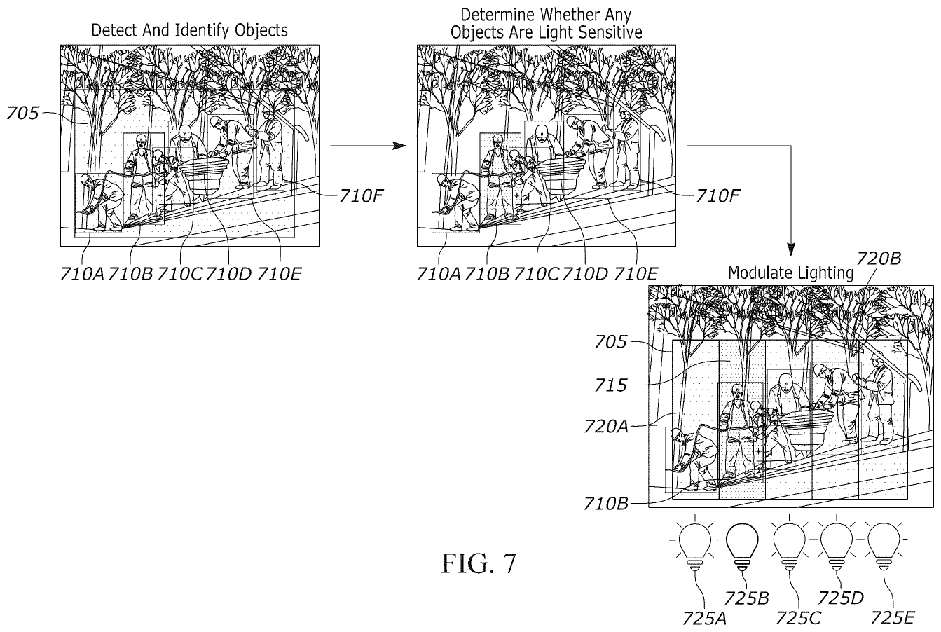

FIG. 7 illustrates an implementation of the method 600 according to one example situation. In the example shown, an area of operation 705 of the light source 105 includes six human construction workers. In some instances, the electronic processor 205 detects and identifies, using machine vision to analyze the data captured by the camera 115, multiple people 710 in the area of operation 705 (at blocks 605 and 610 of FIG. 6). The electronic processor 205 may then determine whether any objects are sensitive to light emitted by the light source 105 (at blocks 615 and 620). For example, the electronic processor 205 may determine, using machine vision to analyze the data captured by the camera 115, that a first gaze direction of a first person 710B of the multiple people is toward the light source 105. The electronic processor 205 may also determine, using machine vision to analyze the data captured by the camera 115, that a second gaze direction of a second person 710A and 710C-F of the multiple people is not toward the light source 105.

The electronic processor 205 may determine, based on the gaze direction determinations, that the first person 710B is sensitive to light emitted by the light source 105 and that the second person 710A and 710C-F are not sensitive to light emitted by the light source 105. The first person 710B may be located in a first section 715 of the area of operation 705, and the second person 710A and 710C-F may be located in a second section 720 of the area of operation 705. As shown in FIG. 7, the second section 720 may include two separate, non-contiguous sections 720A and 720B.

In response to determining that the first person 710B is sensitive to light emitted by the light source 105 and that the second person 710A and 710C-F are not sensitive to light emitted by the light source 105, the electronic processor 205 may (at block 625) control the light source 105 to (i) decrease the brightness of LEDs 725B illuminating the first section 715 of the area of operation in which the first person 710B is located and (ii) maintain the brightness of LEDs 725A and 725C-E illuminating the second section 720A and 720B of the area of operation 705 in which the second person 710A and 710C-F are located. For example, the maintained brightness of LEDs 725A and 725C-E is brighter than the decreased brightness of LEDs 725B (which may include LEDs 725B being turned off completely). The decreased brightness of light toward the onlooking person 710B may reduce or prevent a blindness effect of the light on the onlooking person 710B. In this manner, the area of operation may still be largely illuminated (e.g., for most users) while the LEDs that most directly emit light at the onlooking user are dimmer or disabled to reduce or prevent a blinding effect of the light on the onlooking person 710B.

In some instances, repetition of the method 600 allows the electronic processor 205 to detect that the person 710B has changed their gaze direction to be away from the light source 105 (i.e., the person 710B is no longer light-sensitive based on a changed position/orientation and/or location). In response to such a determination, the LEDs 725B may be re-illuminated at the high/bright level, for example, that corresponds to the same brightness level as the other LEDs 725.

While FIG. 7 includes an example with five subsets of LEDs of the light source 105 that are separately/independently controllable, light modulation resolution (i.e., control granularity) may be different in some instances depending on individual control capabilities of the LEDs of the light source 105 as explained previously herein.

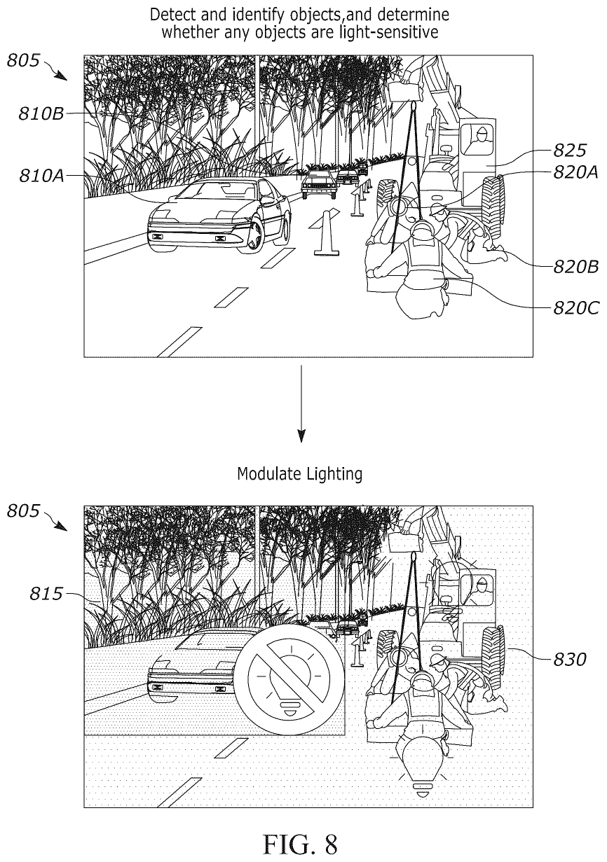

FIG. 8 illustrates another implementation of the method 600 according to another example situation. In the example shown, an area of operation 805 of the light source 105 includes construction workers 820, a construction vehicle 825, and pedestrian vehicles 810. In some instances, the electronic processor 205 identifies, using machine vision to analyze the data captured by the camera 115, a moving vehicle 810 in the area of operation 805 (at blocks 605 and 610). In some instances, the electronic processor 205 may determine that the vehicle 810 is moving by comparing its position in serial (e.g., consecutive) images captures by the camera 115. The electronic processor 205 may also determine that a front or rear of the vehicle is facing the light source 105 (at block 615).

Accordingly, the electronic processor 205 may determine, based on identifying the moving vehicle 810 and its orientation, that the moving vehicle 810 is sensitive to light emitted by the light source 105 (at block 620). The moving vehicle 810 may be located in a first section 815 of the area of operation 805. The electronic processor 205 may also identify humans 820 (e.g., construction workers) and a stationary vehicle 825 (e.g., construction vehicle) in the area of operation 805. However, based on the type, location, and/or orientation of the objects 820 and 825, the electronic processor 205 may determine that these objects 820 and 825 are not sensitive to light emitted by the light source 105. The objects 820 and 825 may be located in a second section of the area of operation 805.

In some instances, in response to determining that the moving vehicle 810 is sensitive to light emitted by the light source 105, the electronic processor 205 controls (at block 625) the light source 105 to (i) decrease the brightness of LEDs illuminating the first section 815 of the area of operation 805 in which the moving vehicle 810 is located and (ii) maintain the brightness of LEDs illuminating the second section 830 of the area of operation in which the moving vehicle 810 is not located as indicated in FIG. 8. For example, the maintained brightness of LEDs illuminating the second section 830 is brighter than the decreased brightness of the LEDs illuminating the first section 815 (which may include such LEDs being turned off completely). The decreased brightness of LEDs illuminating the first section 815 of the area of operation 805 may reduce/prevent glare from being experienced by drivers of the oncoming vehicles 810. For example, road glare from work lights used while performing civil infrastructure or utility work may negatively affect a driver's ability to see the road and/or objects while driving. Existing work lights in these situations may be positioned such that the light beams do not cause excessive glare for drivers. However, such positioning can result in sub-optimal lighting conditions for workers/users. Implementation of the method 600 in the road work situation shown in FIG. 8 addresses this issue by preventing or reducing road glare for drivers while providing adequate work lighting for construction workers.

In some instances, repetition of the method 600 allows the electronic processor 205 to determine when moving vehicles 810 are no longer detected. In response to such a determination, all of the LEDs may be re-illuminated at the high/bright level, for example, that corresponds to the same brightness level as the LEDs configured to illuminate the second section 830). Accordingly, the brightness of subsets of LEDs of the light source 105 may be dynamically controlled based on the detected presence of a moving vehicle (e.g., an oncoming moving vehicle) in the area of operation 805 of the lighting device 100.

In other words, the electronic processor may determine, using machine vision to analyze data captured by the camera 115, that the location, the orientation, or both the location and the orientation of the respective object 810, 710B sensitive to light emitted by the light source 105 has changed such that the respective object 810, 710B is no longer present within the area of operation 805, 705 or such that the respective object 810, 710B is no longer sensitive to light emitted by the light source 105. In response to determining that the location, the orientation, or both the location and the orientation of the respective object 810, 710B sensitive to light emitted by the light source 105 has changed such that the respective object 810, 710B is no longer present within the area of operation 805, 705 or such that the respective object 810, 710B is no longer sensitive to light emitted by the light source 105, the electronic processor 205 may control the light source 105 to increase the brightness of LEDs illuminating the first section 815, 715 of the area of operation 805, 705 back to a previous brightness level (e.g., the same brightness level as the LEDs configured to illuminate the second section 830, 720A, 720B).

Any one or a combination of the features described with respect to FIGS. 6-8 may be combined with each other and/or with other features described herein (e.g., with features of FIGS. 3-5) in a single lighting device 100. Similarly, the pan/tilt/focus mechanism features described below may additionally or alternatively by combined with other features described herein in a single lighting device 100.

In some instances, the electronic processor may control the brightness of the light source 105 (e.g., the brightness of different subsets of LEDs) based on detected ambient light (e.g., based on detected ambient light in different sections of the area of operation). For example, in response to determining that a first section of the area of operation is darker (i.e., less ambient light detected) than a second section of the area of operation, the electronic processor may control a first subset of LEDs that illuminate the first section to be brighter than a second subset of LEDs that illuminate the second section. The electronic processor may control the LEDs in this manner to save power/energy since the darker first section may require more light to adequately illuminate the first section than the second section that is already exposed to more ambient light. In some instances, the electronic processor may control the brightness of different subsets of LEDs such that the brightness of each subset is inversely proportional to an amount of ambient light detected by the electronic processor in a respective section of the area of operation that is illuminated by each subset of LEDs. In some instances, the electronic processor may detect the presence of other lights in the area of operation (e.g., lights on the construction vehicle 825 of FIG. 8). In response to detecting the presence of other lights that are facing the lighting device 100 in a section of the area of operation, the electronic processor may dim or shut off a subset of LEDs that illuminates the section of the area of operation since the other detected lights from another source may be adequately illuminating the section of the area of operation (as indicated by higher detected levels of ambient light in the section). The ambient light in different sections of the area of operation may be detected using a visible light camera(s) and/or a visible/ambient light sensor(s) as part of the vision system 115. Additionally or alternatively, the electronic processor may determine, using machine vision to analyze data captured by a visible light camera and/or sensor and/or other cameras and/or sensors, an amount of ambient light in each section of the area of operation and/or the presence of other light sources and their direction of illumination.

In some instances, the lighting device 100 may include a pan/tilt/focus mechanism configured to actively move the light assembly 102 and/or adjust the light beam output by the light source 105 to illuminate only a desired area of the area of operation. The pan/tilt/focus mechanism may include a powered pan/tilt/focus mechanism to which the light assembly 102 including the light source 105 and the camera/vision system 115 is configured to be mounted. The powered pan/tilt/focus mechanism may receive power from the battery pack 110. In some instances, the electronic processor 205 is coupled to the powered pan/tilt/focus mechanism and is configured to control the powered pan/tilt/focus mechanism to mechanically adjust a direction in which light is emitted from the light source 105, for example, to reduce or change/avoid illumination of sections of the area of operation in which light sensitive objects are present (similar to the method of FIG. 6) and/or sections of the area of operation in which people are not present (similar to the method of FIG. 3), and/or to ensure and/or increase illumination of section of the area of operation in which users are present (similar to the method of FIG. 3). In some instances, the powered pan/tilt/focus mechanism includes one or more motors that are controlled by the electronic processor 205 to adjust a pan/tilt/focus parameter/direction of the light assembly 102. In some instances, the one or more motors may control the light assembly 102 to move within, for example, a ball and socket joint or other joint that, for example, allows for 360-degree rotation of the light assembly 102.

In some instances, the powered pan/tilt/focus mechanism may be used to provide light to desired areas and prevent light from being provided to undesired areas in a similar manner as described above with respect to FIGS. 3-8 except that in addition to or as an alternative to controlling individual subsets of LEDs of the light source 105, the electronic processor 205 may control the powered pan/tilt/focus mechanism to physically/mechanically adjust the light assembly 102 to (i) output light in a desired direction (e.g., by following a user) and/or (ii) avoid outputting light in a non-desirable direction (e.g., avoid outputting light towards an oncoming vehicle and/or an onlooking user). The use of the powered pan/tilt/focus mechanism ensures that the work area is receiving as much light as possible without wasting useful light (and therefore, with wasting unnecessary power) on non-work-areas. Additionally, the use of the powered pan/tilt/focus mechanism reduces or prevents users from having to manually reposition work lights, which may be tedious and time consuming, especially at work sites where the work area is often moving/changing such as civil road construction sites.

Thus, some instances provide, among other things, a lighting device configured to engage in context detection to control a light source based on detected objects.

We claim:

1. A lighting device comprising:
a light source including a plurality of light-emitting diodes (LEDs), wherein the lighting device is a portable lighting device, and wherein at least two subsets of LEDs of the plurality of LEDs are separately controllable to be illuminated at different brightness levels;
a battery pack configured to provide power to the light source;
a thermal camera; and
an electronic processor coupled to the thermal camera, wherein the electronic processor is configured to:
control the thermal camera to capture a background image of an area of operation of the light source,
control the thermal camera to capture a current image of the area of operation of the light source after capturing the background image,
compare the current image to the background image to determine whether one or more people is present in the area of operation,
determine, in response to determining that the one or more people is present in the area of operation, a first section of the area of operation in which the one or more people is located, and
control the light source to more brightly illuminate the first section of the area of operation in which the one or more people is located than a second section of the area of operation in which people are not located.

2. The lighting device of claim 1, wherein the electronic processor is configured to control the thermal camera to capture the background image in response to receiving, via a user interface, a user input.

3. The lighting device of claim 1, further comprising an inertial measurement unit (IMU) sensor, wherein the electronic processor is configured to:
determine, based on data received from the IMU sensor, that the lighting device has been moved after the background image has been captured;
determine that the lighting device has stopped moving and is stationary; and
control the thermal camera to re-capture a second background image in response to determining that the lighting device has stopped moving and is stationary.

4. The lighting device of claim 1, wherein the electronic processor is configured to:
compare a current temperature of each pixel of the current image to a background temperature of a corresponding pixel of the background image;
determine that the background temperature of a first pixel in the background image is greater than the current temperature of the first pixel in the current image;
in response to determining that the background temperature of the first pixel in the background image is greater than the current temperature of the first pixel in the current image,
flag the first pixel as not including people, and
set the background temperature of the first pixel in the background image to be a value of the current temperature of the first pixel in the current image;
determine that the background temperature of a second pixel in the background image is less than the current temperature of the second pixel in the current image by a predetermined threshold; and
in response to determining that the background temperature of the second pixel in the background image is less than the current temperature of the second pixel in the current image by the predetermined threshold, flag the second pixel as including the one or more people.

5. The lighting device of claim 1, wherein the electronic processor is configured to control the light source to illuminate the first section of the area of operation in which the one or more people is located regardless of whether the one or more people has remained stationary for a period of time.

6. The lighting device of claim 1, wherein the electronic processor is configured to dynamically control a brightness of the at least two subsets of LEDs to provide light to different sections of the area of operation as the one or more people move within the area of operation by repeatedly:
controlling the thermal camera to capture additional current images of the area of operation of the light source;
comparing each additional current image to the background image to determine whether one or more people is present in the area of operation;
determining, in response to determining that the one or more people is present in the area of operation, the first section of the area of operation in which the one or more people is located; and
controlling the light source to more brightly illuminate the first section of the area of operation in which the one or more people is located than a second section of the area of operation in which people are not located.

7. The lighting device of claim 1, wherein the thermal camera is mounted adjacent to the light source and is configured such that a field of view of the thermal camera corresponds approximately to the area of operation of the light source.

8. The lighting device of claim 1, further comprising:
a housing;
a telescopic arm assembly supported by the housing;
a light assembly coupled to the telescopic arm assembly and movable relative to the housing, wherein the light assembly includes the light source and the thermal camera; and
one or more leg assemblies coupled to the housing and configured to provide stability and support for the housing during operation of the light source.

9. A method of controlling a lighting device, the method comprising:
controlling, with an electronic processor of the lighting device, a thermal camera of the lighting device to capture a background image of an area of operation of a light source of the lighting device, wherein the light source includes a plurality of light-emitting diodes (LEDs), wherein the lighting device is a portable lighting device, wherein at least two subsets of LEDs of the plurality of LEDs are separately controllable to be illuminated at different brightness levels, and wherein a battery pack coupled to the lighting device is configured to provide power to the light source;
controlling, with the electronic processor, the thermal camera to capture a current image of the area of operation of the light source after capturing the background image;
comparing, with the electronic processor, the current image to the background image to determine whether one or more people is present in the area of operation;
determining, with the electronic processor and in response to determining that the one or more people is present in the area of operation, a first section of the area of operation in which the one or more people is located; and
controlling, with the electronic processor, the light source to more brightly illuminate the first section of the area of operation in which the one or more people is located than a second section of the area of operation in which people are not located.

10. The method of claim 9, wherein controlling the thermal camera to capture the background image includes controlling, with the electronic processor, the thermal camera to capture the background image in response to receiving, via a user interface, a user input.

11. The method of claim 9, further comprising:
determining, with the electronic processor and based on data received from an inertial measurement unit (IMU) sensor of the lighting device, that the lighting device has been moved after the background image has been captured;
determining, with the electronic processor, that the lighting device has stopped moving and is stationary; and
controlling, with the electronic processor, the thermal camera to re-capture a second background image in response to determining that the lighting device has stopped moving and is stationary.

12. The method of claim 9, wherein comparing the current image to the background image to determine whether one or more people is present in the area of operation includes:
comparing, with the electronic processor, a current temperature of each pixel of the current image to a background temperature of a corresponding pixel of the background image;
determining, with the electronic processor, that the background temperature of a first pixel in the background image is greater than the current temperature of the first pixel in the current image;
in response to determining that the background temperature of the first pixel in the background image is greater than the current temperature of the first pixel in the current image,
flagging, with the electronic processor, the first pixel as not including people, and
setting, with the electronic processor, the background temperature of the first pixel in the background image to be a value of the current temperature of the first pixel in the current image;
determining, with the electronic processor, that the background temperature of a second pixel in the background image is less than the current temperature of the second pixel in the current image by a predetermined threshold; and
in response to determining that the background temperature of the second pixel in the background image is less than the current temperature of the second pixel in the current image by the predetermined threshold, flagging, with the electronic processor, the second pixel as including the one or more people.

13. The method of claim 9, wherein controlling the light source to more brightly illuminate the first section of the area of operation than the second section of the area of operation includes controlling, with the electronic processor, the light source to illuminate the first section of the area of operation in which the one or more people is located regardless of whether the one or more people has remained stationary for a period of time.

14. The method of claim 9, further comprising dynamically controlling, with the electronic processor, a brightness of the at least two subsets of LEDs to provide light to different sections of the area of operation as the one or more people move within the area of operation by repeatedly:
controlling, with the electronic processor, the thermal camera to capture additional current images of the area of operation of the light source;
comparing, with the electronic processor, each additional current image to the background image to determine whether one or more people is present in the area of operation;
determining, with the electronic processor and in response to determining that the one or more people is present in the area of operation, the first section of the area of operation in which the one or more people is located; and
controlling, with the electronic processor, the light source to more brightly illuminate the first section of the area of operation in which the one or more people is located than a second section of the area of operation in which people are not located.

15. The method of claim 9, wherein the thermal camera is mounted adjacent to the light source and is configured such that a field of view of the thermal camera corresponds approximately to the area of operation of the light source.

16. A lighting device comprising:
a light source including a plurality of light-emitting diodes (LEDs), wherein the lighting device is a portable lighting device, and wherein at least two subsets of LEDs of the plurality of LEDs are separately controllable to be illuminated at different brightness levels;
a battery pack configured to provide power to the light source;
a camera; and
an electronic processor coupled to the camera, wherein the electronic processor is configured to:
detect, using machine vision to analyze data captured by the camera, one or more objects in an area of operation of the light source,
identify, using machine vision to analyze the data captured by the camera, an object type of each of the one or more objects,
determine, using machine vision to analyze the data captured by the camera, a location and an orientation of each of the one or more objects,
determine, at least partially based on the object type, whether the location and the orientation of each of the one or more objects makes a respective object sensitive to light emitted by the light source, and
in response to determining that the location and the orientation of the respective object makes the respective object sensitive to light emitted by the light source, control the light source to (i) decrease a brightness of LEDs illuminating a first section of the area of operation in which the respective object sensitive to light emitted by the light source is located and (ii) maintain a brightness of LEDs illuminating a second section of the area of operation in which the respective object sensitive to light emitted by the light source is not located.

17. The lighting device of claim 16, wherein the electronic processor is configured to:
identify, using machine vision to analyze the data captured by the camera, multiple people in the area of operation;
determine, using machine vision to analyze the data captured by the camera, that a first gaze direction of a first person of the multiple people is toward the light source;
determine, using machine vision to analyze the data captured by the camera, that a second gaze direction of a second person of the multiple people is not toward the light source;
determine, based on the gaze direction determinations, that the first person is sensitive to light emitted by the light source and that the second person is not sensitive to light emitted by the light source, wherein the first person is located in the first section of the area of operation, and wherein the second person is located in the second section of the area of operation; and
in response to determining that the first person is sensitive to light emitted by the light source and that the second person is not sensitive to light emitted by the light source, control the light source to (i) decrease the brightness of LEDs illuminating the first section of the area of operation in which the first person is located and (ii) maintain the brightness of LEDs illuminating the second section of the area of operation in which the second person is located.

18. The lighting device of claim 16, wherein the electronic processor is configured to:
identify, using machine vision to analyze the data captured by the camera, a moving vehicle in the area of operation;
determine, based on identifying the moving vehicle, that the moving vehicle is sensitive to light emitted by the light source, wherein the moving vehicle is located in the first section of the area of operation; and
in response to determining that the moving vehicle is sensitive to light emitted by the light source, control the light source to (i) decrease the brightness of LEDs illuminating the first section of the area of operation in which the moving vehicle is located and (ii) maintain the brightness of LEDs illuminating the second section of the area of operation in which the moving vehicle is not located.

19. The lighting device of claim 16, wherein the electronic processor is configured to:
determine, using machine vision to analyze data captured by the camera, that the location, the orientation, or both the location and the orientation of the respective object sensitive to light emitted by the light source has changed such that the respective object is no longer present within the area of operation or such that the respective object is no longer sensitive to light emitted by the light source; and
in response to determining that the location, the orientation, or both the location and the orientation of the respective object sensitive to light emitted by the light source has changed such that the respective object is no longer present within the area of operation or such that the respective object is no longer sensitive to light emitted by the light source, control the light source to increase the brightness of LEDs illuminating the first section of the area of operation back to a previous brightness level.

20. The lighting device of claim 16, further comprising a powered pan/tilt/focus mechanism to which a light assembly including the light source and the camera is configured to be mounted, wherein the powered pan/tilt/focus mechanism receives power from the battery pack, and wherein the electronic processor is coupled to the powered pan/tilt/focus mechanism and is configured to control the powered pan/tilt/focus mechanism to mechanically adjust a direction in which light is emitted from the light source to reduce illumination of the first section of the area of operation in which the respective object sensitive to light emitted by the light source is located.
